(19) United States
(12) Patent Application Publication
(10) Pub. No.: US 2020/0269786 A1
(43) Pub. Date: Aug. 27, 2020

(54) Power Window Circuit

(71) Applicant: Gilbert Brian Weaver, Sunman, IN (US)

(72) Inventor: Gilbert Brian Weaver, Sunman, IN (US)

(21) Appl. No.: 16/803,760

(22) Filed: Feb. 27, 2020

Related U.S. Application Data
(60) Provisional application No. 62/811,363, filed on Feb. 27, 2019.

(51) Int. Cl. B60R 16/03; B60J 1/17; E05F 15/695

(52) U.S. Cl. CPC B60R 16/0307; E05F 15/695; B60J 1/17

(57) ABSTRACT

A car window circuit is provided. The car window circuit provides a closed-circuit voltage step up converter that increases the car window movement speed of slow or old window power circuits. The car window circuit contains a DC converter module, a case, an electrical input, an electrical output, and a circuit check module. The DC converter module resides within the case, serving as the voltage step up converter. The electrical input, the electrical output, and a ground wiring are electrically connected to the DC converter module. The circuit check module is electrically connected between the electrical input and the DC converter module, serving as the car window circuit voltage regulator. When installed to a window power circuit, the car window circuit will indicate successful installation through the activation and illumination of a power indicator LED and a bridge indicator LED.

The current application claims a priority to the U.S. Provisional Patent application Ser. No. 62/811,363 filed on Feb. 27, 2019.

### FIELD OF THE INVENTION

The present invention relates generally to a vehicle window circuits. More particularly, automotive electronics and accessories.

### BACKGROUND OF THE INVENTION

As a vehicle ages, its power windows operate at a much slower speed. It is an objective of the present invention to address this issue by providing users with a contained circuit that makes old power windows work like new.

The present invention is easy to install. The user simply needs to locate the window power fuse slot in the vehicle circuit breaker. The user can then replace the window power fuse with the present invention. Finally, the user can then ground the present invention to a suitable ground connection, such as a vehicle frame bolt. Once installed, the present invention optimizes the window power circuit by enhancing the voltage, while decreasing the amperage draw of the vehicle. The present invention also features voltage and amperage regulation features, prolonging the performance and life of the power window switch, power window motor, or any other components that constitutes the window power circuit. Furthermore, the present invention features indicators that diagnoses a faulty window power circuit such as open circuit faults, short circuits, or insufficient voltage/amperage draw.

### SUMMARY OF THE INVENTION

The present invention is a car window circuit. The car window circuit comprises a DC converter module, a case, an electrical input, an electrical output, and a circuit check module. The car window circuit may take the form of a contained circuit that increases the voltage while lowering the amp load to the window motor of a vehicle, increasing the window movement speed in older vehicles with sluggish window movement speeds. Additionally, the car window circuit prolongs the life of the vehicle window circuit by regulating voltage and amperage flow to safe and optimal levels.

The DC converter module is positioned within the case. In the preferred embodiment of the present invention, the case serves as a protective housing for the electronic components that constitutes car window circuit In the preferred embodiment of the present invention, the case is made out of an insulative, weather-proof, durable, hard plastic material, but can be made out of any other suitable material such as, but not limited to hard rubber, aluminum, silicone, wood, or any other suitable material. In the preferred embodiment of the present invention, the case may take the form of a rectangular box shape, allowing the case to install within a vehicle door panel compartment or any other suitable space. In various embodiments, the case may take the form of any other suitable shape, such as but not limited to spherical, elliptical, or triangular shapes. In the preferred embodiment of the present invention, the DC converter module may take the form of a step-up voltage converter, increasing the 12V vehicle power input to optimal voltage levels while lowering the amperage draw to the window motor of the vehicle.

### BRIEF DESCRIPTION OF THE DRAWINGS

FIG. 1 is a front perspective view of the present invention.

FIG. 2 is a top perspective view of the present invention.

FIG. 3 is an exploded top perspective view of the present invention.

FIG. 4 is a top perspective view of a case body used in the present invention.

FIG. 5 is a side view of the case body used in the present invention.

FIG. 6 is a top perspective view of a cover used in the present invention.

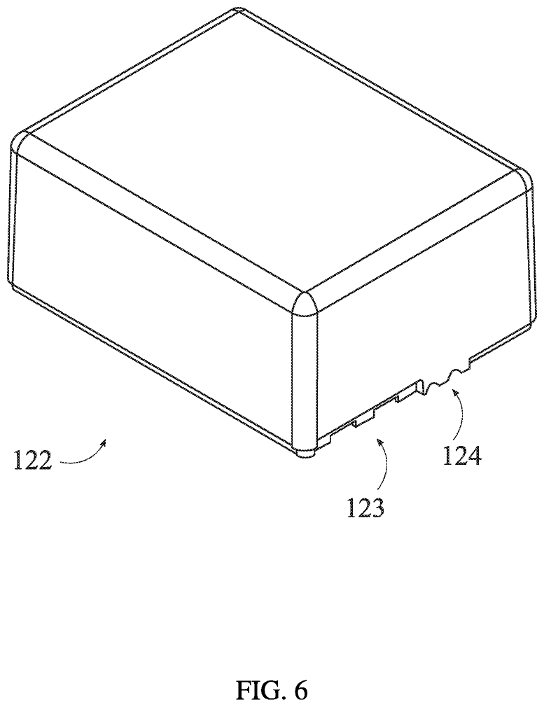

FIG. 7 is a side view of the cover used in the present invention.

FIG. 8 is a box circuit diagram used in the present invention.

FIG. 9 is circuit diagram that constitute the electronic components used in the present invention.

### DETAIL DESCRIPTIONS OF THE INVENTION

All illustrations of the drawings are for the purpose of describing selected versions of the present invention and are not intended to limit the scope of the present invention. The present invention is to be described in detail and is provided in a manner that establishes a thorough understanding of the present invention. There may be aspects of the present invention that may be practiced or utilized without the implementation of some features as they are described. It should be understood that some details have not been described in detail in order to not unnecessarily obscure focus of the invention. References herein to “the preferred embodiment”, “one embodiment”, “some embodiments”, or “alternative embodiments” should be considered to be illustrating aspects of the present invention that may potentially vary in some instances, and should not be considered to be limiting to the scope of the present invention as a whole.

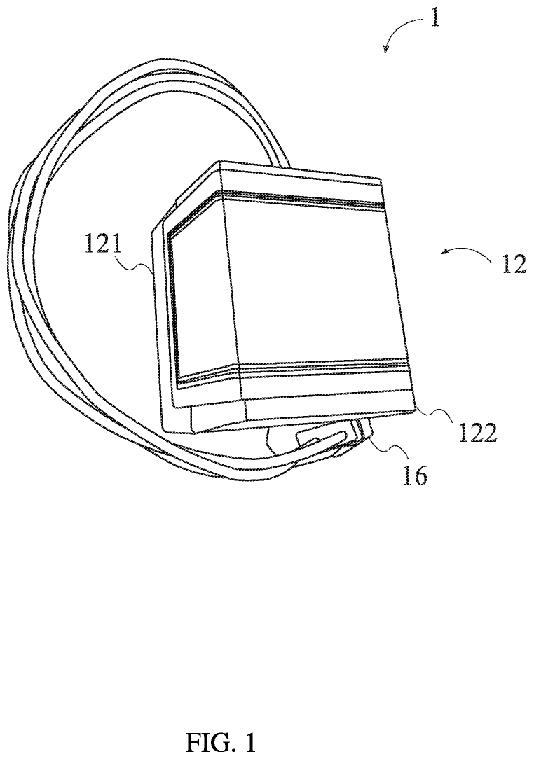

In reference to FIGS. 1-3 and 8-9, the present invention is a car window circuit 1. The car window circuit 1 comprises a DC converter module 11, a case 12, an electrical input 14, an electrical output 13, and a circuit check module 15. The car window circuit 1 may take the form of a contained circuit that increases the voltage while lowering the amp load to the window motor of a vehicle, increasing the window movement speed in older vehicles with sluggish window movement speeds. Additionally, the car window circuit 1 prolongs the life of the vehicle window circuit by regulating voltage and amperage flow to safe and optimal levels.

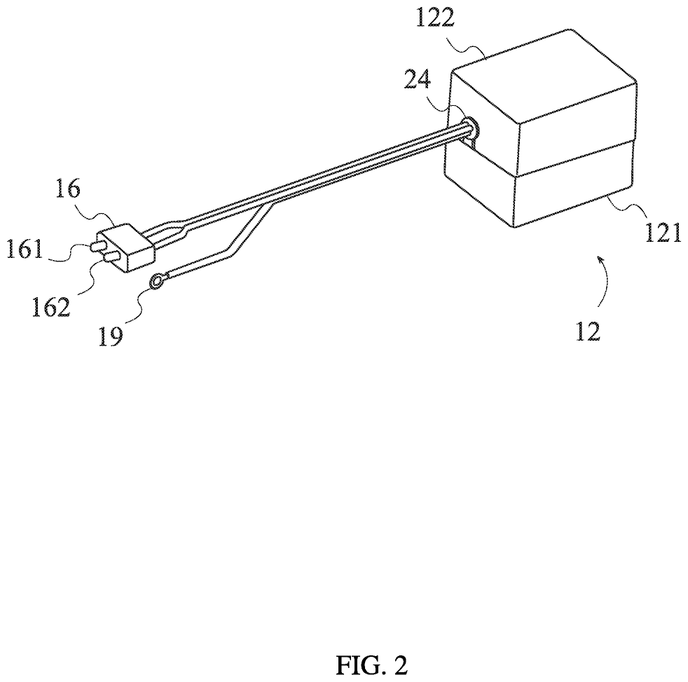

The DC converter module 11 is positioned within the case 12, as shown in FIG. 2. In the preferred embodiment of the present invention, the case 12 serves as a protective housing for the electronic components that constitutes car window circuit 1. In the preferred embodiment of the present invention, the case 12 is made out of an insulative, weather-proof, durable, hard plastic material, but can be made out of any other suitable material such as, but not limited to hard rubber, aluminum, silicone, wood, or any other suitable material. In the preferred embodiment of the present invention, the case 12 may take the form of a rectangular box shape, allowing the case 12 to install within a vehicle door panel compartment or any other suitable space. In various embodiments, the case 12 may take the form of any other suitable shape, such as but not limited to spherical, elliptical, or triangular shapes. In the preferred embodiment of the present invention, the DC converter module 11 may take the form of a step-up voltage converter, increasing the 12V vehicle power input to optimal voltage levels while lowering the amperage draw to the window motor of the vehicle.

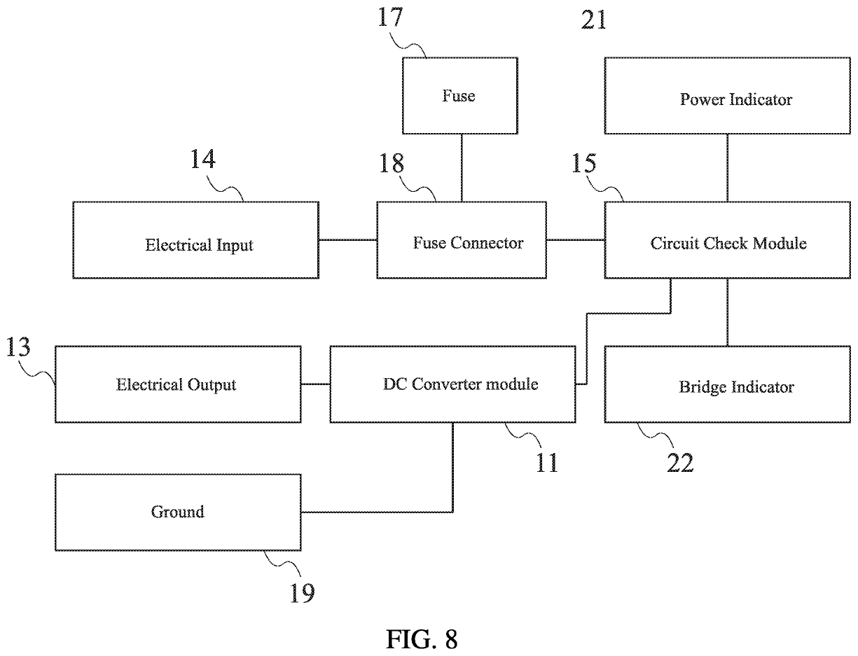

The electrical input 14 is electrically connected to the DC converter module 11, as shown in FIG. 8. In the preferred embodiment of the present invention, the electrical input 14 may take the form of an electrical conduit or wire that bridges the input electrical connection of the 12V power supply to the DC converter module 11. The electrical output 13 is electrically connected to the DC converter module 11, as shown in FIG. 8. In the preferred embodiment of the present invention, the electrical output 13 may take the form of an electrical conduit or wire that bridges the output electrical connection of the stepped-up voltage produced by the DC converter module 11 to the vehicle window motor. In reference to FIG. 8, the circuit check module 15 is electrically connected between the electrical input 14 and the DC converter module 11 where the circuit check module 15 is configured to determine whether the car window circuit 1 is capable of operating at a specified voltage threshold. More specifically, the circuit check module 15 regulates the voltage and amperage draw that feeds into the DC converter module 11, serving as a safety gateway, preventing insufficient power, voltage spikes, or over-amperage from damaging the DC converter module 11.

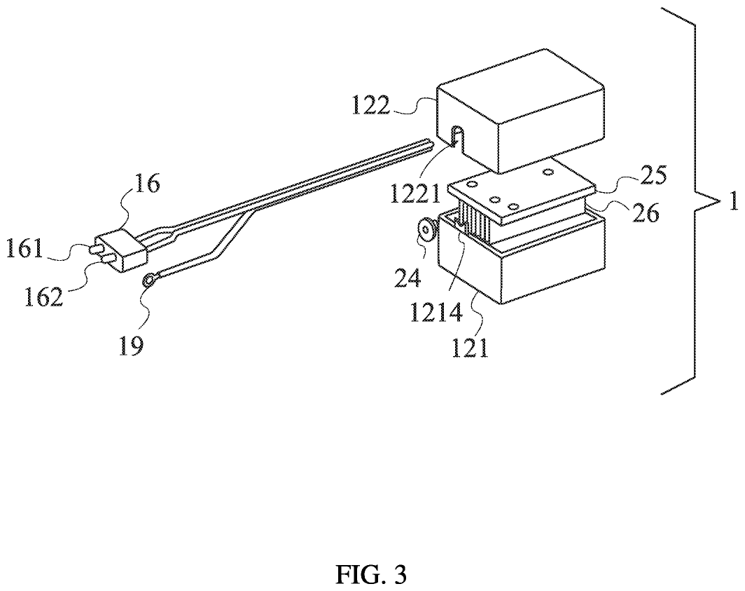

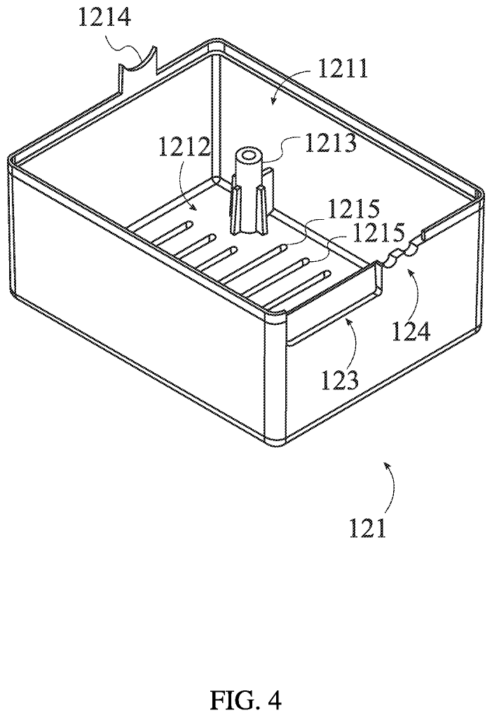

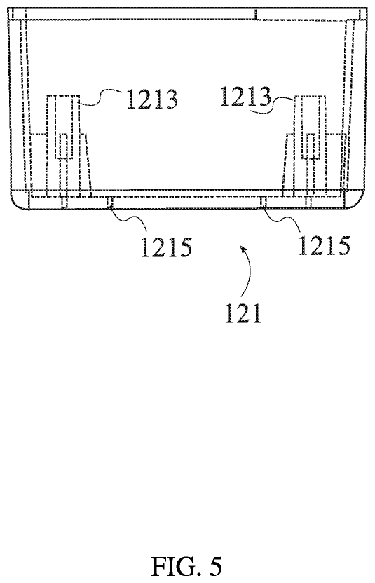

In the preferred embodiment of the present invention, the car window circuit 1 further comprises a circuit breaker connector 16, a fuse 17, a fuse connector 18, a power indicator 21, and a bridge indicator 22, a grommet 24, a ground 19, an electronics board 25, and a heatsink 26. The case 12 comprises a case body 121 and a cover 122, as shown in FIGS. 4-5. The case body 121 is connected adjacent to the cover 122, as shown in FIGS. 1-3. In the preferred embodiment of the present invention, the case body 121 mounts and secures the electronic components that constitute the car window circuit 1. The case body 121 comprises an electronics cavity 1211, electronics mounting surface 1212, at least one electronics mounting bracket 1213, a seal mounting tab 1214, and a plurality of vent apertures 1215. The electronics cavity 1211 is positioned within the case body 121, as shown in FIG. 4. In the preferred embodiment of the present invention, the electronics cavity 1211 serves as the interior chamber of the case body 121 that facilitates the mounting and placement of the electronic components that constitutes the car window circuit 1. The electronics mounting surface 1212 is positioned within the electronics cavity 1211. The electronics mounting surface 1212 portion of the case body 121 serves as the mounting surface for the at least one electronics bracket. In the preferred embodiment of the present invention, the at least one electronics mounting bracket 1213 is connected on the electronics mounting surface 1212. The seal mounting tab 1214 is connected to the case body 121 opposite to the electronics mounting surface 1212. The seal mounting tab 1214 is positioned between the case body 121 and the cover 122. The seal mounting tab 1214 facilitates the connection of the grommet 24 to the case body 121. In reference to FIG. 3, the grommet 24 is connected between the seal mounting tab 1214 and the at least one light aperture 1221. In the preferred embodiment of the present invention, the grommet 24 serves as a protective seal for the wiring that constitutes the electrical output 13, the electrical input 14, and the ground 19 connections. The plurality of vent apertures 1215 traverses through the case body 121. The plurality of vents allows air to pass through the case body 121, cooling the DC converter module 11 and circuit check module 15.

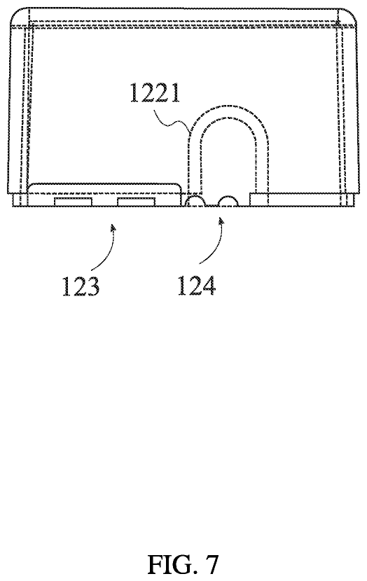

The cover 122 comprises a wire aperture 1221. In the preferred embodiment of the present invention, the cover 122 closes off the electronics cavity 1211 and protects the electronic components that constitutes the car window circuit 1. The wire aperture 1221 is aligned with a seal mounting tab 1214 of the case body 121. In reference to FIGS. 3 and 7, the wire aperture 1221 traverses through the cover 122. The wire aperture 1221 allows the electrical input 14, the electrical output 13, and ground 19 wires to traverse through the case 12. In the preferred embodiment of the present invention, the case 12 further comprises at least one light aperture 124, and a fuse aperture 123. The at least one light aperture 124 traverses through the case 12. The fuse aperture 123 traverses through the case 12. The at least one aperture secures and mounts the power indicator 21 and the bridge indicator 22 to the case 12.

The circuit breaker connector 16 comprises an electrical input terminal 161 and an electrical output terminal 162, as shown in FIGS. 1-3. The electrical input terminal 161 is electrically connected with the electrical input 14. The electrical output terminal 162 is electrically connected with the electrical output 13. In the preferred embodiment of the present invention, the circuit breaker connector 16 may take the form of a connector plug that allows the user to install the car window circuit 1 to the vehicle window power fuse 17 box. In the preferred embodiment of the present invention, the electrical input terminal 161 and the electrical output terminal 162 can be di-similar from each other such that the circuit breaker connector 16 only installs in one electrical configuration, preventing the possibilities of a reverse polarity connection. The ground 19 is electrically connected to the DC converter module 11, as shown in FIG. 8. In the preferred embodiment of the present invention, the ground 19 connection serves as the electrical ground 19 for the car window circuit 1.

In the preferred embodiment of the present invention, the fuse connector 18 is electrically connected between the electrical input 14 and the circuit check module 15, as shown in FIG. 8. The fuse 17 is electrically connected with the fuse connector 18. The fuse 17 is electrically connected between the electrical input 14 and the circuit check module 15. The fuse connector 18 is aligned with the fuse aperture 123. In the preferred embodiment of the present invention, the fuse 17 is removably attached to the fuse connector 18. The fuse 17 serves as an amperage safety cut-off device for the circuit check indicator, such that the fuse 17 will blow when the receiving amperage from the electrical input 14 exceeds the amperage safety threshold of the fuse 17. In the preferred embodiment of the present invention, the fuse connector 18 facilitates a quick and easy means of replacing a blown fuse 17.

In reference to FIG. 8, the power indicator 21 is electrically connected with the circuit check module 15. The bridge indicator 22 is electrically connected with the circuit check module 15. In the preferred embodiment of the present invention, the power indicator 21 and the bridge indicator 22 each is aligned with one of the at least one light aperture 124. In the preferred embodiment of the present invention, the power indicator 21 indicates that current is running through the circuit check module 15, indicating that electrical input 14 current is closed or not shorted. In the preferred embodiment of the present invention, the bridge indicator 22 indicates that current is running through the DC converter module 11, prompting that the amperage draw provides sufficient input for the DC converter module 11. In the preferred embodiment of the present invention, the power indicator 21 and bridge indicator 22 may take the form of a LED diodes, but may take the form of any other type of indicator such as, but not limited to audible beepers, vibrator pulse devices, or any other suitable indicators.

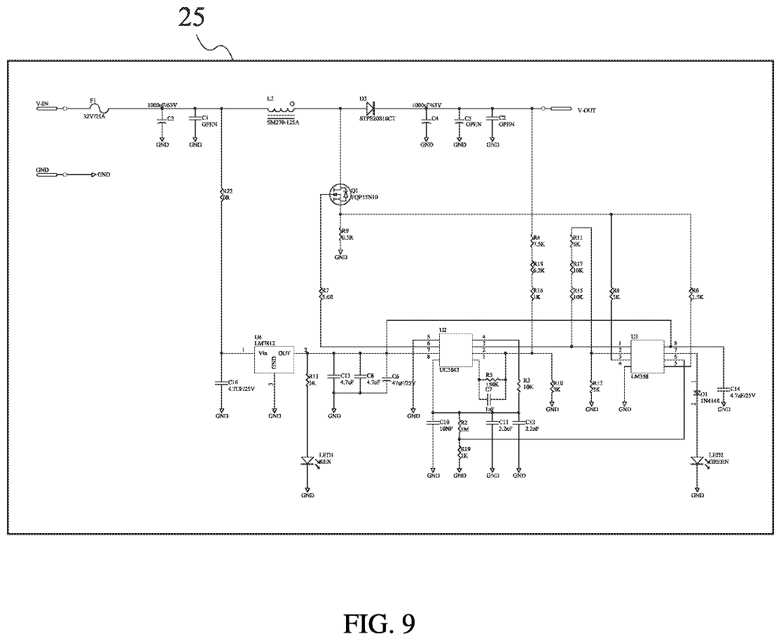

In reference to FIG. 3, the electronics board 25 is connected adjacent to the electronics mounting bracket of the case 12. The DC converter module 11 and the circuit check module 15 is connected to the electronics board 25. In the preferred embodiment of the present invention, the electronics board 25 may take the form of an PCB board that integrates the DC converter module 11 and circuit check module 15 together, as shown in FIG. 9. In the preferred embodiment of the present invention, the electronic components that constitutes the electronics board may take the form of a specific arrangement of diodes, capacitors, resistors, step up converters, relays, or any other suitable components to achieve step up and voltage or amperage regulative functions, as shown in FIG. 9. The electronics board 25 may take the form of a PCB board that mounts the DC converter module 11 and the circuit check module 15 in to one electronic unit. In reference to FIG. 3, the heatsink 26 is connected adjacent to the DC converter module 11 and the circuit check module 15. In the preferred embodiment of the present invention, the heatsink 26 may take the form of a finned heatsink 26 that dissipates heat emitted from the DC converter and the circuit check module 15.

Although the invention has been explained in relation to its preferred embodiment, it is to be understood that many other possible modifications and variations can be made without departing from the spirit and scope of the invention as hereinafter claimed.

What is claimed is:

1. A car window circuit comprising:
a DC converter module;
a case;
an electrical input;
an electrical output;
a circuit check module;
the DC converter module being positioned within the case;
the electrical input being electrically connected to the DC converter module;
the electrical output being electrically connected to the DC converter module; and
the circuit check module being electrically connected between the electrical input and the DC converter module; wherein the circuit check module is configured to determine whether the car window circuit is capable of operating at a specified voltage threshold.

2. The car window circuit as claimed in claim 1 comprising:
the case comprising a case body and a cover; and
the case body being connected adjacent to the cover.

3. The car window circuit as claimed in claim 2 comprising:
the case body comprising an electronics cavity, an electronics mounting surface, at least one electronics mounting bracket, a seal mounting tab, and a plurality of vent apertures;
the electronics cavity being positioned within the case body;
the electronics mounting surface being positioned within the electronics cavity;
the at least one electronics mounting bracket being connected on the electronics mounting surface;
the seal mounting tab being connected to the case body opposite to the electronics mounting surface;
the seal mounting tab being positioned between the case body and the cover; and
the plurality of vent apertures traversing through the case body.

4. The car window circuit as claimed in claim 2 comprising:
the cover comprising a wire aperture;
the wire aperture traversing through the cover; and
the wire aperture being aligned with a seal mounting tab of the case body.

5. The car window circuit as claimed in claim 1 comprising:
the case comprising at least one light aperture, and a fuse aperture;
the at least one light aperture traversing through the case; and
the fuse aperture traversing through the case.

6. The car window circuit as claimed in claim 1 comprising:
a circuit breaker connector;
the circuit breaker connector comprising an electrical input terminal and an electrical output terminal;
the electrical input terminal being electrically connected with the electrical input; and
the electrical output terminal being electrically connected with the electrical output.

7. The car window circuit as claimed in claim 1 comprising:
a fuse; and
the fuse being electrically connected between the electrical input and the circuit check module.

8. The car window circuit as claimed in claims 1 comprising:
a fuse connector;
a fuse;
the case comprising a fuse aperture;
the fuse connector being electrically connected between the electrical input and the circuit check module;
the fuse being electrically connected with the fuse connector; and
the fuse connector being aligned with the fuse aperture.

9. The car window circuit as claimed in claim 1 comprising:
a power indicator;
a bridge indicator;
the case comprising at least one light aperture;
the power indicator being electrically connected with the circuit check module;
the bridge indicator being electrically connected with the circuit check module; and
the power indicator and the bridge indicator each being aligned with one of the at least one light aperture.

10. The car window circuit as claimed in claim 1 comprising:
a grommet;
a case body of the case comprising a seal mounting tab;
a cover of the case comprising a wire aperture; and
the grommet being connected between the seal mounting tab and the wire aperture.

10. The car window circuit as claimed in claim 1 comprising:
a grommet;
a case body of the case comprising a seal mounting tab;
a cover of the case comprising a wire aperture; and
the grommet being connected between the seal mounting tab and the wire aperture.

11. The car window circuit as claimed in claim 1 comprising:
a ground; and
the ground being electrically connected to the DC converter module.

12. The car window circuit as claimed in claim 1 comprising:
an electronics board; and
the electronics board being connected adjacent to an electronics mounting bracket of the case.

13. The car window circuit as claimed in claim 1 comprising:
a heatsink; and
the heatsink being connected adjacent to the DC converter module and the circuit check module.
